(19) United States
(12) Patent Application Publication
(10) Pub. No.: US 2008/0228670 A1
(43) Pub. Date: Sep. 18, 2008

(54) Interacting with a user via a personal information manager user interface

(76) Inventors: Iryna Vogler-Ivashchanka, Los Altos, CA (US); Kim Lessley, Edmonds, WA (US); Stefan Ehrler, Biblis (DE); Michael Becherer, Hanhofen (DE); Florian Hery, Mannheim (DE)

Correspondence Address: FISH & RICHARDSON, P.C., PO BOX 1022, MINNEAPOLIS, MN, 55440-1022, US

(21) Appl. No.: 11/725,146

(22) Filed: Mar. 15, 2007

(51) Int. Cl. G06F 17/00

(52) U.S. Cl. 705/500

(57) ABSTRACT

Systems and techniques for interacting with a user via a personal information manager user interface. In another aspect, a system can include a recruiting server that provides services related to a recruiting process and manages data associated with the recruiting process, a personal information manager server that provides services related to management of a user's personal information, and a personal information manager user interface on one or more I/O devices. The personal information manager user interface can integrates, into a single display screen, personal information from the personal information manager server and the data associated with the recruiting process.

### BACKGROUND

This disclosure relates to systems and techniques for interacting with a user via a personal information manager user interface.

Computers and other data processing devices interact with human users to convey and receive information. Such interactions occur in a variety of different ways, including the display of icons, the rendition of video and images, the playing of sound, the receipt of text and other input, and the like. The mechanisms of interaction between a data processing device and a user can be governed by the logic of a computer program or other set of machine-readable instructions. For example, the arrangement of a display screen, the consequences of user interaction with icons and elements, and the way that text is input can be governed by such logic.

A personal information manager is one example of a set of machine-readable instructions that governs the mechanisms of interaction between a user and a data processing device. The activities of personal information managers are generally designed to integrate and manage the “personal information” of an individual, along with the associated processes. Such personal information can include personal notes, journals, communication archives (e-mail/instant message/fax), schedules, task lists, contact information, and the like. Personal information processes can include the sending and receipt of e-mail, the recording and access of contact information, the entry and deletion of tasks and notes, the docketing of scheduled events, the issuance of event reminders, and the like. A personal information manager can be implemented in software, in hardware, or in combinations thereof.

A personal information manager need not manage every category of personal information, nor must a personal information manager perform every management activity on the managed personal information. Instead, a personal information manager can perform a subset of processes on a subset of the personal information described above. Thus, messaging systems, e-mail applications, calendar applications, and the like are examples of personal information managers. Specific examples of personal information managers include MICROSOFT OUTLOOK and OUTLOOK EXPRESS, MOZILLA THUNDERBIRD, MUTT, NOVELL GROUPWARE, NETSCAPE MESSENGER, QUALCOMM EUDORA, web-based e-mail programs (such as HUSHMAIL, and MUTEMAIL), PEGASUS MAIL, LOTUS NOTES, and the like.

Other sets of machine-readable instructions can be designed to perform other sets of data processing activities. For example, word processing applications can be designed to integrate and manage the data and processes associated with word processing. As another example, recruiting applications can be designed to integrate and manage the data and processes associated with the recruiting of individuals to an employer or other organization. Recruiting data and processes can thus include, e.g., requisitions for personnel, communications with recruited individuals and with individuals involved in the recruiting process, trackings of the progress of recruited individuals through the recruiting process, scheduling of activities in the recruiting process, storage of contact information for recruited individuals, scoring of individuals in the recruiting process, and the like.

### SUMMARY

Systems and techniques for interacting with a user via a personal information manager user interface are described.

In one aspect, a method includes receiving, at a user interface of a personal information manager, requisition information and candidate information from a recruiting server that manages data associated with recruiting individuals to an enterprise, and rendering, in the personal information manager user interface, the requisition information and the candidate information. The personal information manager user interface is generated in accordance with the logic of a personal information manager for the management of personal information of a human user. The requisition information describes a request to fill a position. The candidate information describes an individual who is a candidate to fill the position.

This and other aspects can include one or more of the following features. The requisition information can include identifiers of two or more candidates to fill the requisition in association with an identifier of the requisition. The method can include receiving user interaction identifying a first of the identifiers and in response, rendering at least some candidate information describing an individual who is associated with the first of the identifiers. The requisition information can also include a description of one or more requirements on candidates to fill the requisition in association with an identifier of the requisition, a description of a salary for the position in association with an identifier of the requisition.

The rendering of the requisition information can include rendering, in a region of the personal information manager user interface, an identifier of a collection of requisitions and an identifier of a collection of communications that have been archived for the human user, and in response to user interaction with the identifier of the requisition collection, rendering information describing the requisitions in the requisition collection.

Rendering the candidate information can include rendering identifiers of two or more requisitions for which the individual is a candidate in association with an identifier of the candidate. The method can include receiving user interaction identifying a first of the identifiers and in response, rendering at least some requisition information describing a requisition that is associated with the first of the identifiers.

Rendering the requisition information can also include rendering, in a region of the personal information manager user interface, an identifier of a collection of candidate and an identifier of a collection of contacts that have been archived for the human user and, in response to user interaction with the identifier of the candidate collection, rendering information describing the candidates in the candidate collection.

The method can also include receiving, at the user interface, recruiting task information from the recruiting server and rendering, in the personal information manager user interface, the recruiting task information. The recruiting task information can describe a task performed in filling the position. Rendering the recruiting task information can include rendering, in a region of the personal information manager user interface, an identifier of a collection of recruiting tasks and an identifier of a collection of other tasks that have been archived for the human user and, in response to user interaction with the identifier of the recruiting task collection, rendering information describing the recruiting tasks in the recruiting task collection. The recruiting task information can include identifiers of two or more recruiting tasks performed in filling a first requisition in association with an identifier of the first requisition.

The method can also include receiving user interaction identifying a first of the identifiers and, in response, rendering at least some recruiting task information describing a recruiting task that is associated with the first of the identifiers. The recruiting task information can include identifiers of two or more recruiting tasks performed in recruiting a first candidate in association with an identifier of the first candidate.

The method can also include receiving user interaction identifying a first of the identifiers and, in response, rendering at least some recruiting task information describing a recruiting task that is associated with the first of the identifiers.

In another aspect, a system can include a recruiting server that provides services related to a recruiting process and manages data associated with the recruiting process, a personal information manager server that provides services related to management of a user's personal information, and a personal information manager user interface on one or more I/O devices. The personal information manager user interface can integrates, into a single display screen, personal information from the personal information manager server and the data associated with the recruiting process.

This and other aspects can include one or more of the following features. The personal information manager user interface can include a display screen that comprises a first region for displaying names of mail folders and a second region for displaying contents of mail folders. The first region can include a name of a collection of requisitions. The second region can include names of requisitions in the collection of requisitions.

The personal information manager user interface can include a display screen that comprises a first region for displaying names of contact lists and a second region for displaying contents of contact lists. The first region can include a name of a collection of candidates. The second region can include names of candidates in the collection of candidates.

The personal information manager user interface can include a display screen that comprises a first region for displaying names of task lists and a second region for displaying contents of task lists. The first region can include a name of a collection of recruiting tasks. The second region can include names of recruiting tasks in the collection of recruiting tasks.

The personal information manager user interface can include a rendition of a requisition. The requisition can be a request to fill a position. The requisition rendition can include a collection of identifiers of one or more candidates who have been assigned to the requisition for consideration in filling the position, basic information regarding the position, and/or salary information regarding a salary for the position.

The personal information manager user interface can include a rendition of a recruiting task. The recruiting task can be a task performed in filling a position. The recruiting task rendition can include recruiting context information describing a context of the recruiting task in a recruiting process and/or an identifier of a letter template that is suited for performance of the recruiting task.

The personal information manager user interface can include a rendition of a candidate. The candidate can be an individual to be considered for filling a position. The candidate rendition can include a collection of two or more identifiers of requisitions for which the individual is to be considered, a collection of two or more identifiers of tasks in recruiting the individual to the position, and/or a profile of qualifications of the individual.

The system can also include a recruiting user interface on the one or more I/O devices. The recruiting user interface can be operable to modify the data associated with the recruiting process.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a system landscape in which a recruiting application can interact with a human user via the user interface of a personal information manager (PIM).

FIG. 2 is a schematic representation of a display that includes visual elements of a PIM user interface.

FIGS. 3, 4 are schematic representations of portions of a PIM user interface that can be used by a human user to interact with a recruiting application.

FIG. 5 shows a rendition of a requisition in a portion of a display.

FIGS. 6-9 shows aspects of the rendition of the requisition of FIG. 5.

FIG. 10 shows another rendition of a requisition in a portion of a display.

FIG. 11 is a schematic representation of portions of a PIM user interface that can be used by a human user to interact with a recruiting application.

FIG. 12 shows a rendition of a candidate in a portion of a display.

FIGS. 13, 14 shows aspects of the rendition of the candidate of FIG. 12.

FIG. 15 is a schematic representation of portions of a PIM user interface that can be used by a human user to interact with a recruiting application.

FIG. 16 shows a rendition of a task in a portion of a display.

FIG. 17 shows another aspect of rendition of the task of FIG. 16.

FIG. 18 shows a rendition of a meeting request in a portion of a display.

FIG. 19 shows a rendition of a candidate ranking form in a portion of a display.

FIG. 20 is a schematic representation of a system landscape in which a recruiting application can interact with a human user both via the user interface of a personal information manager (PIM) and via the user interface of a recruiting application.

Like reference symbols in the various drawings indicate like elements.

### DETAILED DESCRIPTION

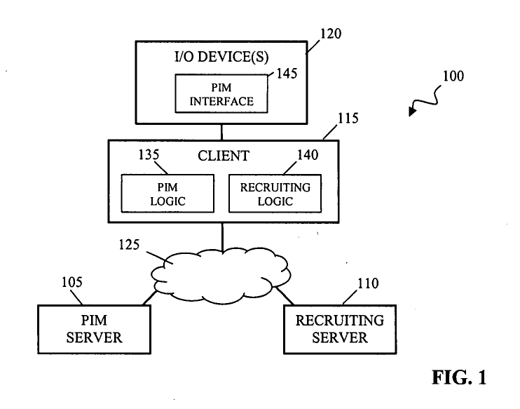

FIG. 1 is a schematic representation of a system landscape 100 in which a recruiting application can interact with a human user via the user interface of a personal information manager (PIM). In particular, a recruiting application can convey information to a human user and receive information from the human user via the user interface of a personal information manager (PIM). System landscape 100 includes a PIM server 105, a recruiting server 110, and a client 115 that interact with a user over one or more I/O devices 120. PIM server 105, a recruiting server 110, a client 115 can exchange information over one or more data links 125.

PIM server 105 is a system that provides services to integrate and manage the personal information of an individual, along with the associated processes. PIM server 105 can provide the services in response to service requests received from other components of system landscape 100, including client 115 and recruiting server 110. PIM server 105 can be a discrete device or a discrete set of data processing activities performed by a data processing device.

Recruiting server 110 is a system that provides services to integrate and manage the data and processes associated with the recruiting of individuals to an organization. Recruiting server 110 can provide the services in response to service requests received from other components of system landscape 100, including client 115. Recruiting server 110 can be a discrete device or a discrete set of data processing activities performed by a data processing device. For example, the data processing activities of PIM server 105 and recruiting server 110 can be performed by a single device.

Client 115 is a system that receives services from PIM server 105 and recruiting server 110 during the performance of data processing activities. The data processing activities performed by client 115 can be performed in accordance with the logic of sets of machine readable instructions. For example, client 115 can perform data processing activities in accordance with a set of PIM logic 135 and a set of recruiting logic 140. The data processing activities of recruiting logic 140 can request and receive services from recruiting server 110. The data processing activities of PIM logic 135 can request and receive services from PIM server 105, for example, using the messaging application program interface (MAPI) standard of the MICROSOFT WINDOWS operating system. The data processing activities of PIM logic 135 can also be used to create and operate a PIM user interface 145 on one or more I/O devices 120.

I/O devices 120 are one or more devices for interacting with a user. The interaction can include the input and output of data. I/O devices 120 can include, e.g., one or more visual, auditory, and mechanical input and output devices, such as computer monitors, LCD screens, keyboards, microphones, speakers, computer mice, Braille outputs, and the like. I/O devices 120 can be used to render a user interface of a personal information manager (PIM), such as PIM user interface 145.

PIM user interface 145 is a mechanism for the exchange of information with a human user. The exact nature of PIM user interface 145 can depend on the I/O devices 120 on which PIM user interface 145 is rendered. For example, if I/O devices 120 include a speaker, PIM user interface 145 can include sound elements. As another example, if I/O devices 120 include a display (such as a computer monitors or the LCD screen of a PDA), PIM user interface 145 can include visual elements.

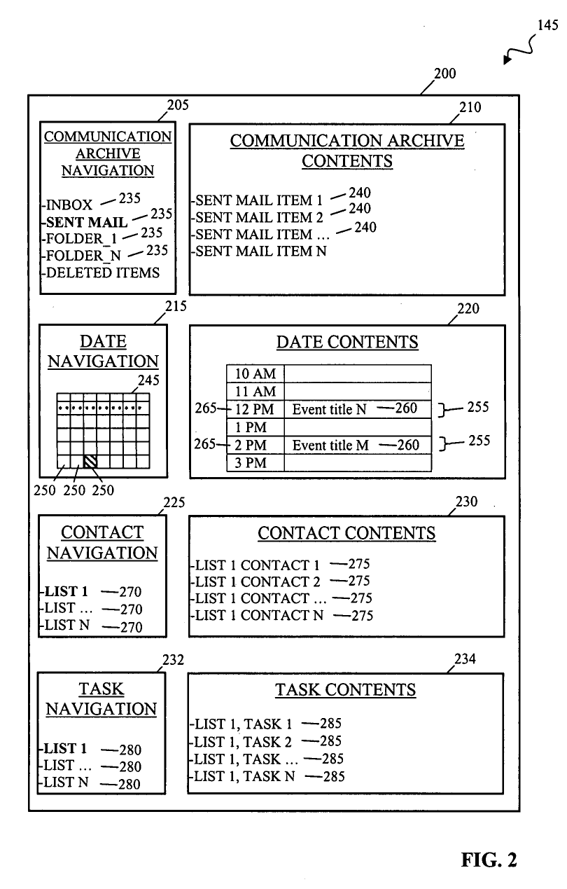

FIG. 2 is a schematic representation of a display 200 that includes visual elements of a PIM user interface 145. In particular, display 200 includes a communication archive navigation region 205, a communication archive contents region 210, a date navigation region 215, a date contents region 220, a contact navigation region 225, a contact contents region 230, a task navigation region 232, a task contents region 234.

Communication archive navigation region 205 is a portion of display 200 that renders the organization of communication archives for a user. Communication archives can be organized, e.g., in a collection of folders 235. Folders 235 can be arranged in a hierarchical arrangement. The disposition of communications within folders 235 can be based on one or more characteristics of the communications, such as whether the communications constitute incoming communications, sent communications, deleted communications, relate to a certain topic, are received from a certain sender, or the like.

In some implementations, the rendition of the organization of communication archives can facilitate user navigation through the communication archives. For example, a user can navigate to a portion of the communication archives by selecting that portion from communication archive navigation region 205. Such a selection can include, e.g., a user double-clicking on a folder 235 in communication archive navigation region 205. The navigation to this portion can be used to trigger the rendition of the communications in this folder 235 of the communication archives in communication archive contents region 210.

Communication archive contents region 210 is a portion of display 200 that renders a list of at least some of the contents of one or more portions of a communication archive. The listed contents can include communications 240 that are archived in a folder 235. The listing of a communication can include, e.g., the display of a subject line, a date, and/or a communication partner associated with the communication. One or more folders 235 whose contents are listed in communication archive contents region 210 can be identified in communication archive navigation region 205 using a visual indicium such as boldface type (as shown with “sent mail” folder 235).

In some implementations, the rendition of a list of communications in communication archive contents region 210 can facilitate user navigation through an archive of communications 240. For example, a user can navigate to a particular communication 240 in the communication archives by selecting that communication 240 from the list in communication archive contents region 210. Such a selection can include, e.g., a user double-clicking on communication 240 in communication archive contents region 210. The navigation to communication 240 can be used to trigger the rendition of additional or even all of the information regarding of the selected communication 240 in a portion of display 200.

Date navigation region 215 is a portion of display 200 that renders the organization of scheduled event archives for a user. Scheduled event archives can be organized in a calendar 245 according to the calendar day 250 on which a scheduled event occurs.

In some implementations, the rendition of the organization of scheduled event archives can facilitate user navigation through the event archives. For example, a user can navigate to scheduled events by selecting a day 250 from date navigation region 215. Such a selection can include, e.g., a user double-clicking on day 250 in calendar representation 245. The navigation to day 250 can be used to trigger the rendition of the scheduled events for day 250 in date contents region 220.

Date contents region 220 is a portion of display 200 that renders at least some of the scheduled events 255 for one or more dates in accordance with scheduled event archives. The rendering of a schedule of events 255 can include the display of a title of an event 260 in association with a time 265 when the event is scheduled to occur. One or more days 250 whose schedules are rendered in date contents region 220 can be identified in date navigation region 215 using a visual indicium such as cross hatching (as shown).

In some implementations, the rendition of a schedule of events 255 in date contents region 220 can facilitate user navigation through an archive of events 260. For example, a user can navigate to a particular event 260 in the schedule by selecting that event 260 from the schedule of events 255. Such a selection can include, e.g., a user double-clicking on the event 260. The navigation to this event 260 can be used to trigger the rendition of a fuller description of this event 260 in a portion of display 200.

Contact navigation region 225 is a portion of display 200 that renders the organization of contact archives for a user. Contact archives can be organized, e.g., in a collection of contact lists 270. The disposition of contacts within contact lists 270 can be based on one or more characteristics of the contacts, such as whether the contact is a work contact, a personal contact, associated with an organization, or the like.

In some implementations, the rendition of the organization of contact archives can facilitate user navigation through the contact archives. For example, a user can navigate to a particular contact list 270 by selecting the contact list 270 from contact navigation region 225. Such a selection can include, e.g., a user double-clicking on the contact list 270 in contact navigation region 225. The navigation to contact list 270 can be used to trigger the rendition of a list of the contacts in contact list 270 in contact contents region 230.

Contact contents region 230 is a portion of display 200 that renders at least some of a list of one or more contacts in a contact archive. The rendered contacts can include contacts 275 that are archived in a list 270. The rendering of a list of contacts can include, e.g., the display of contact names, e-mail addresses, postal addresses, phone numbers, and the like. One or more contact lists 270 whose content contacts are listed in contact contents region 230 can be identified in contact navigation region 225 using a visual indicium such as boldface type (as shown for “list 1” contact list 270).

In some implementations, the rendition of contacts in contact contents region 230 can facilitate user navigation through an archive of contacts. For example, a user can navigate to a particular contact 275 in the contact archives by selecting that contact 275 from a list in contact contents region 230. Such a selection can include, e.g., a user double-clicking on contact 275 in contact contents region 230. The navigation to contact 275 can be used to trigger the rendition of additional or even all of the information regarding the selected contact 275 in a portion of display 200.

Task navigation region 232 is a portion of display 200 that renders the organization of task archives for a user. Task archives can be organized, e.g., in a collection of task lists 280. The disposition of tasks within task lists 280 can be based on one or more characteristics of the tasks, such as whether the task is related to recruiting activities or the like.

In some implementations, the rendition of the organization of task archives can facilitate user navigation through the task archives. For example, a user can navigate to a particular task list 280 by selecting the task list 280 from task navigation region 232. Such a selection can include, e.g., a user double-clicking on the task list 280 in task navigation region 232. The navigation to task list 280 can be used to trigger the rendition of a list of the task in task list 280 in task contents region 234.

Task contents region 234 is a portion of display 200 that renders at least some of a list of one or more tasks in a task archive. The rendered tasks can include tasks 285 that are archived in a list 280. The rendering of a list of tasks can include, e.g., the display of task names or subjects, the status of tasks, the due date of tasks, the percent completion of a task, and the like. One or more task lists 280 whose content tasks are listed in task contents region 234 can be identified in task navigation region 232 using a visual indicium such as boldface type (as shown for “list 1” contact list 280).

In some implementations, the rendition of tasks in task contents region 234 can facilitate user navigation through an archive of tasks. For example, a user can navigate to a particular task 285 in the task archives by selecting that task 285 from a list in task contents region 234. Such a selection can include, e.g., a user double-clicking on task 285 in task contents region 234. The navigation to task 285 can be used to trigger the rendition of additional or even all of the information regarding the selected task 285 in a portion of display 200.

Although regions 205, 210, 215, 220, 225, 230, 232, 234 are shown on a single display 200, regions 205, 210, 215, 220, 225, 230, 232, 234 can also be rendered individually or in subgroups on a display. For example, regions 205, 210, 215, 220, 225, 230, 232, 234 can be rendered in succession on a series of displays in accordance with a user's interaction with an I/O device 120. As another example, regions 205, 210, regions 215, 220, regions 225, 230, and regions 232, 234 can be rendered as associated pairs on a collection of displays. Switching between the displays can be performed in accordance with a user's interaction with an I/O device 120. For the sake of brevity and convenience, various groupings of implementations of regions 205, 210, 215, 220, 225, 230, 232, 234 are illustrated hereinafter on a single display that is denoted as display 200. However, the illustrated regions can also be rendered individually or in conjunction with other regions.

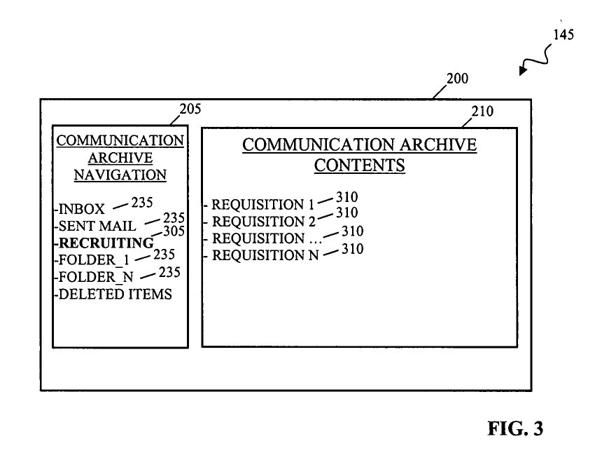

FIG. 3 is a schematic representation of portions of a PIM user interface 145 in which implementations of regions 205, 210 are rendered together on display 200 and can be used by a human user to interact with a recruiting application.

In particular, communication archive navigation region 205 includes one or more recruiting folders 305. Recruiting folders 305 archive a collection of recruiting requisitions. A requisition is a request to fill a position. A requisition generally includes information about the position (including duties, location, hours, and the like), salary information, and any requirements that a candidate must meet to be considered for the position. A requisition can be generated by an individual who is responsible for managing personnel in a company or other entity, such as a manager in a human resources department.

The requisitions archived in recruiting folders 305 can be received by PIM logic 135 from recruiting server 110 for integration into the display of personal information on PIM interface 145. For example, PIN logic 135 can receive the requisitions by a push or a pull mechanism, either directly from recruiting server 110 or over recruiting logic 140 (FIG. 1).

The disposition of requisitions in multiple recruiting folders 305 can be based on one or more characteristics of the requisitions, such as the department of the requestor, the nature of the position, the candidate requirements, or the like. A user can navigate to a particular recruiting folder 305 by selecting the recruiting folder 305 from communication archive navigation region 205. Such a selection can include, e.g., a user double-clicking on a particular recruiting folder 305 in communication archive navigation region 205. The navigation to a particular recruiting folder 305 can be used to trigger the rendition of the requisitions in this particular recruiting folder 305 in communication archive contents region 210.

Communication archive contents region 210 can render a list of one or more requisitions 310. The list can include requisitions 310 that are archived in a recruiting folder 305. The rendering of a requisition can include the display of a list of identifiers of the requisitions. One or more recruiting folders 305 whose contents are rendered in communication archive contents region 210 can be identified in communication archive navigation region 205 using a visual indicium such as boldface type (as shown with “recruiting” folder 305).

In some implementations, the rendition of requisitions 310 in communication archive contents region 210 can facilitate user navigation through an archive of requisitions 310. For example, a user can navigate to a particular requisition 31 0.in the communication archives by selecting that requisition 310 from communication archive contents region 210. Such a selection can include, e.g., a user double-clicking on a particular requisition 310 in communication archive contents region 210 or checking a box associated with a particular requisition 310. The navigation to requisition 310 can be used to trigger the rendition of additional details regarding the selected requisition 310 in a portion of display 200. The rendition of a requisition 310 can include the rendition of information about the position (including duties, location, hours, and the like), salary information, and any requirements that a candidate must meet to be considered for the position.

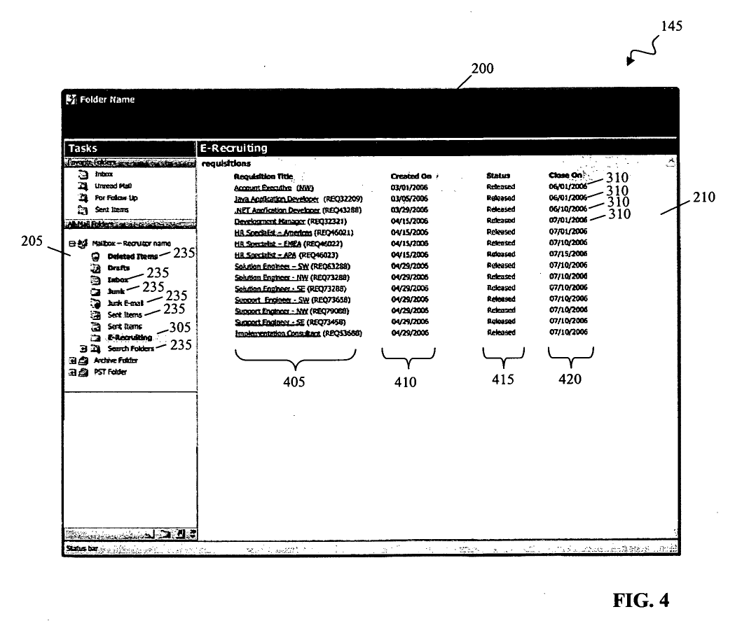

FIG. 4 is a schematic representation of portions of another PIM user interface 145 in which implementations of regions 205, 210 are rendered together on display 200 and can be used by a human user to interact with a recruiting application.

Communication archive navigation region 205 includes one or more recruiting folders 305 (denoted “E-Recruiting” in FIG. 4) that archives a collection of recruiting requisitions. A user can navigate to recruiting folder 305 to trigger the rendition of requisitions 310 in this particular recruiting folder 305 in communication archive contents region 210. The rendering of a requisition 310 can include the display of a collection 405 of position titles, a collection 410 of dates on which the requisitions were created, a collection 415 of identifiers of the status of the requisitions, and a collection 420 of dates on which the requisitions were filled or otherwise closed. In some implementations, a user can navigate to a particular requisition 310 by selecting that requisition 310 from communication archive contents region 210.

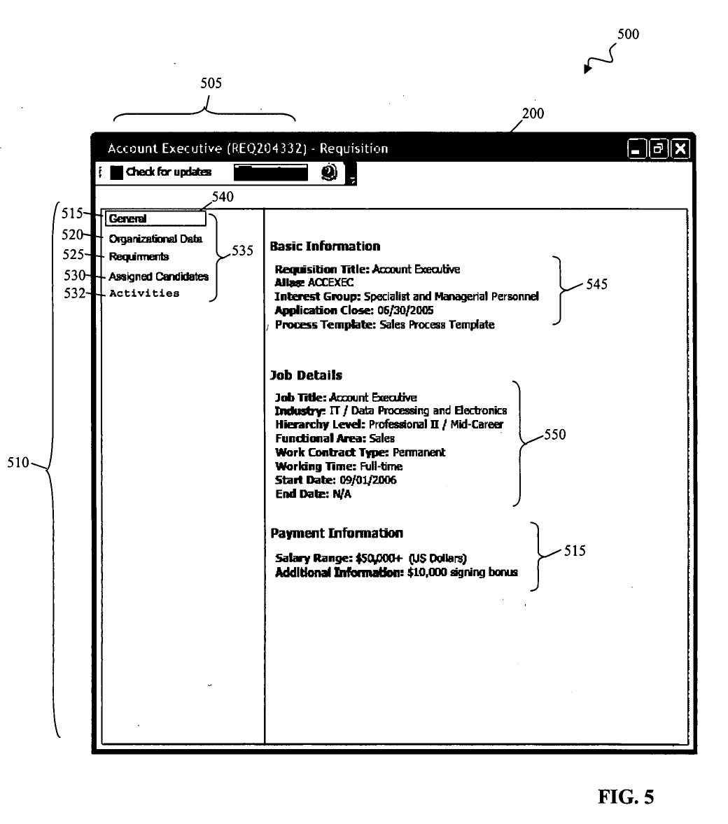

FIG. 5 shows a rendition 500 of information describing a requisition, such as a requisition 310 (FIGS. 3, 4), in a portion of a display 200. Rendition 500 can be rendered separately from portions of PIM user interface 145 in which implementations of regions 205, 210 are rendered. For example, rendition 500 can be rendered in a separate pop-up window or other discrete portion of display 200.

Rendition 500 includes a requisition identifier 505 and a collection 510 of information regarding the requisition. Requisition identifier 505 can include a title of the position and a numeric or other identifier of the requisition, as shown. Requisition information collection 510 can include various categories of information, including general information 515 regarding the position, organizational information 520 regarding the disposition of the position in the organization, requirements information 525 regarding the requirements for an individual who is to fill the position, candidate information 530 describing individuals who have been assigned for consideration to fill the position, and activity information 532 describing activities undertaken to fill the position.

Information 515, 520, 525, 530, 532 can be displayed simultaneously in rendition 500 or individually, e.g., in response to a user selection of a desired one of information 515, 520, 525, 530, 532 for display from a selection menu 535. Selection menu 535 can include a visual indicium of the currently selected one of information 515, 520, 525, 530, 532 such as a box 540. In the illustrated implementation, box 540 indicates that general information 515 is selected for display, whereas information 520, 525, 530, 532 is not. General information 515 includes basic information about the position 545, more detailed information regarding the position 550, and salary information regarding the position 555.

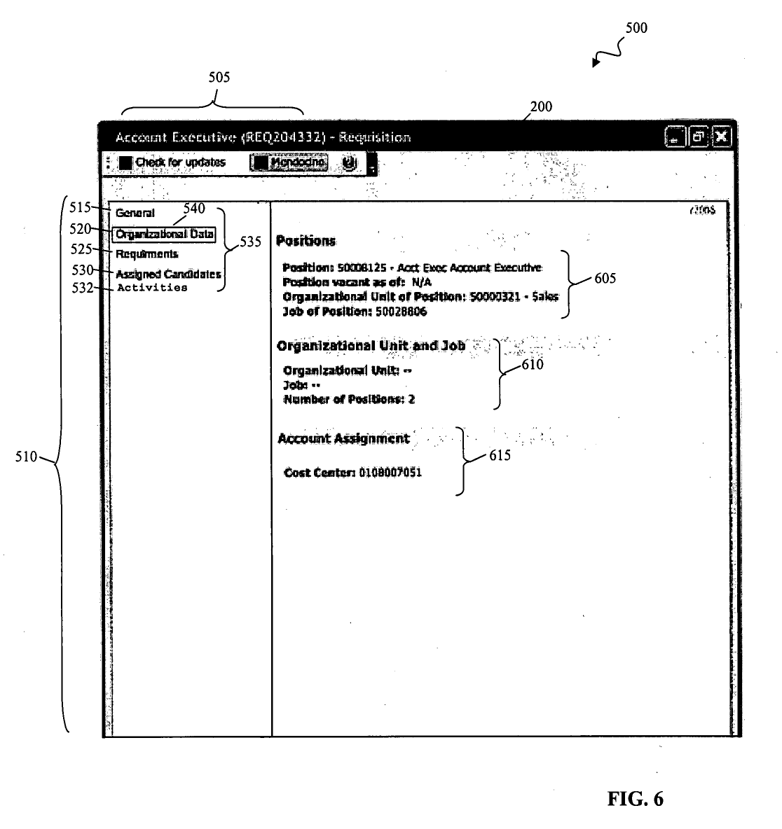

FIG. 6 shows another aspect of requisition rendition 500. In particular, box 540 in selection menu 535 of this aspect of requisition rendition 500 shows that a user has selected organizational information 520 for display, but not information 515, 525, 530, 532. Organizational information 520 includes basic information about the organization unit of the position 605, more detailed information regarding the organization unit 610 (including the number of open positions in this organizational unit), and account assignment information 615 regarding the cost center that pays for the position.

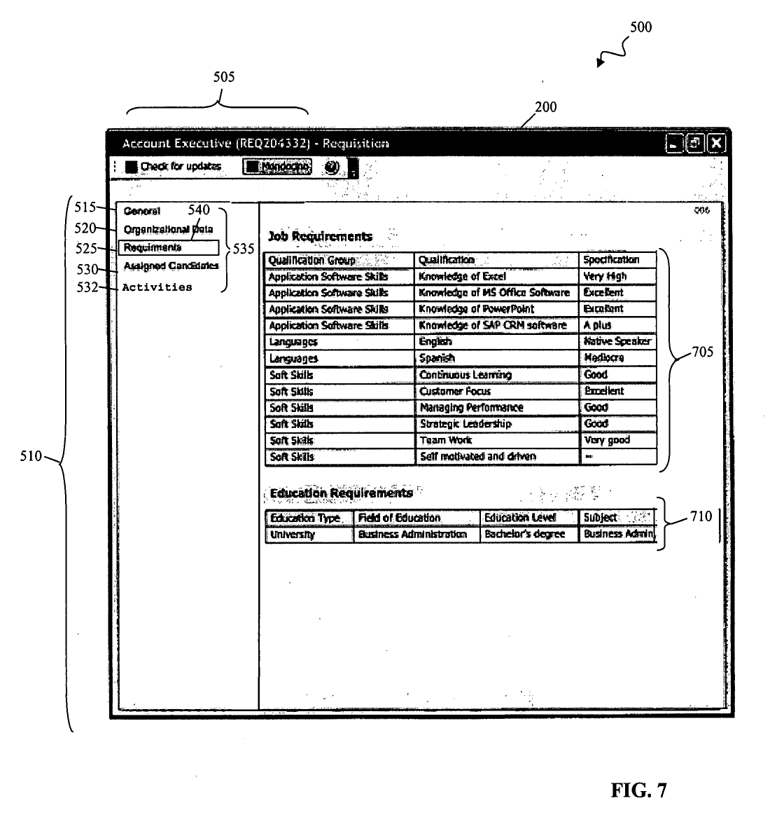

FIG. 7 shows another aspect of requisition rendition 500. In particular, box 540 in selection menu 535 of this aspect of requisition rendition 500 shows that a user has selected requirements information 525 for display, but not information 515, 520, 530, 532. Requirements information 525 includes information 705 regarding the skills required of an individual who is to fill the position and information 710 regarding the educational background required of an individual who is to fill the position. The skills describe in information 705 can include soft skills (such as management experience, sales experience, customer service experience, and the like), hard skills (such as experience with specific software applications, specific hardware, typing, machinist skills, professional certifications, and the like), and other items (including language fluency, a willingness to travel, a willingness to work a certain shift, and the like).

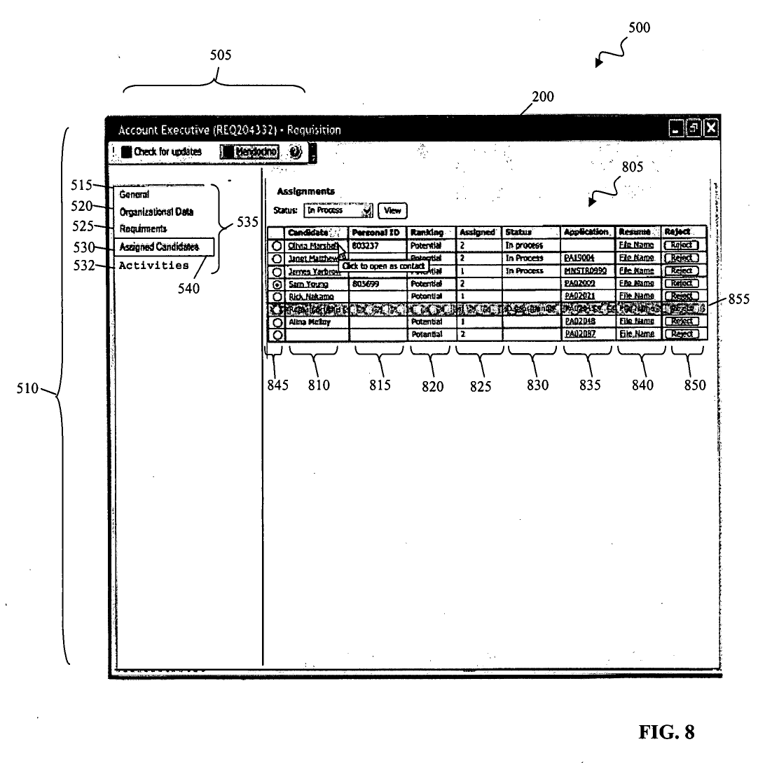

FIG. 8 shows another aspect of requisition rendition 500. In particular, box 540 in selection menu 535 of this aspect of requisition rendition 500 shows that a user has selected candidate information 530 for display, but not information 515, 520, 525, 532. Candidate information 530 includes information 805 regarding the individuals who have been designated as candidates for filling the requisitioned position. Information 805 can include a collection 810 of candidate names. Each name in collection 810 can be associated with additional information, such as a personal identification number 815, ranking information 820, assignment information 825, status information 830, a link 835 or other identifier of the candidate's application information, and a link 840 or other identifier of the candidate's resume.

Candidate information 530 can also include one or more interactive elements by which a user can view additional information or modify a candidate's application. The interactive elements can be part of the display of information regarding the individuals who have been designated as candidates. For example, links 835, 840 can be hyperlinks that can receive a user selection that triggers the display of a candidate's application or resume. As another example, the names in collection 810 can also be hyperlinks that trigger the display of additional information regarding the candidate.

The interactive elements in candidate information 530 need not be part of the display of information regarding the individuals who have been designated as candidates. For example, the interactive elements can be associated with information regarding the individuals who have been designated as candidates. Such associated interactive elements are shown as selection buttons 845 and reject buttons 850. Selection buttons 845 can receive user interaction that triggers the display of additional information regarding the candidate. Reject buttons 850 can receive user interaction that triggers the rejection of an individual's application. The rejection of an individual's application can be denoted by a visual indicium, such as the dark shading 855 of the information describing candidate “Roman Bruchis.”

FIG. 9 shows another aspect of requisition rendition 500. In particular, box 540 in selection menu 535 of this aspect of requisition rendition 500 shows that a user has selected activity information 532 for display, but not whereas information 515, 520, 525, 530. Activity information 532 can include one or more lists or other groupings of activity information 910. Activity information 910 cam describe activities that are associated with filling the requisitioned position. The described activities can include phone interviews, personal interviews, follow-ups with interviewers, and the like. The descriptive information can include, e.g., the time and date when the activities are to occur, the names of the individuals who are participating in the activities, and the names of the candidates to whom the activities are relevant. Activity information 910 can be listed or grouped in accordance with one or more characteristic of the activities, such as the date (as shown), the participating personnel, the candidates to whom the activities are relevant, or the like.

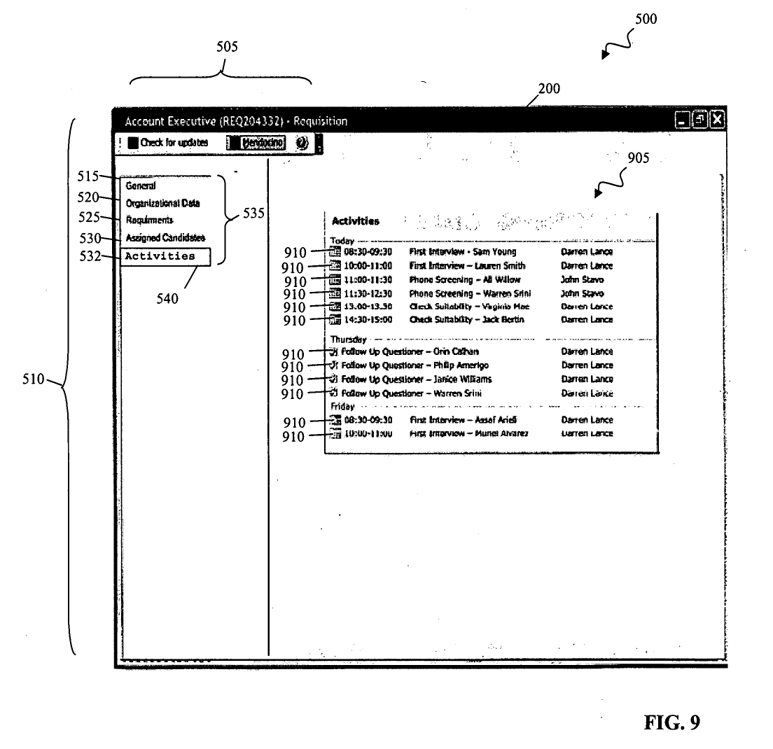

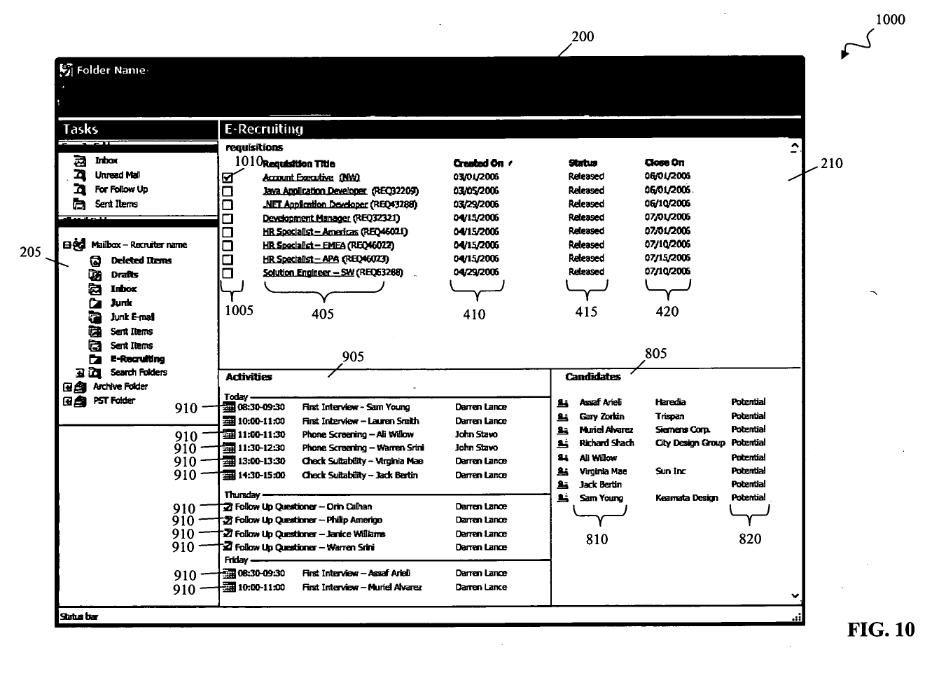

FIG. 10 shows a rendition 1000 of information describing a requisition, such as requisition 310 (FIGS. 3, 4) in a portion of display 200. In particular, rendition 1000 includes a rendition of activity information 905 and candidate information 850. Activity information 905 and candidate information 850 can be rendered in conjunction with the portions of PIM user interface 145 in which implementations of regions 205, 210 are rendered. For example, activity information 905 and candidate information 850 can be rendered in the same window as regions 205, 210.

As shown, the rendering of requisitions in communication archive contents region 210 not only includes the display of collections 405, 410, 415, 420, but also includes the display of a collection 1005 of selection indicia by which a user can navigate to a particular requisition. The selection indicia in collection 1005 can include a collection of boxes, each of which is associated with a requisition, as shown. The selection of a particular requisition can be denoted by the display of a check or other mark 1010 in the associated box.

The rendition of selection indicia collection 1005 in communication archive contents region 210 can be used to facilitate user navigation to a particular requisition. In particular, upon selection of a particular requisition, activity information 905 and candidate information 850 regarding that requisition can be displayed in a portion of display 200.

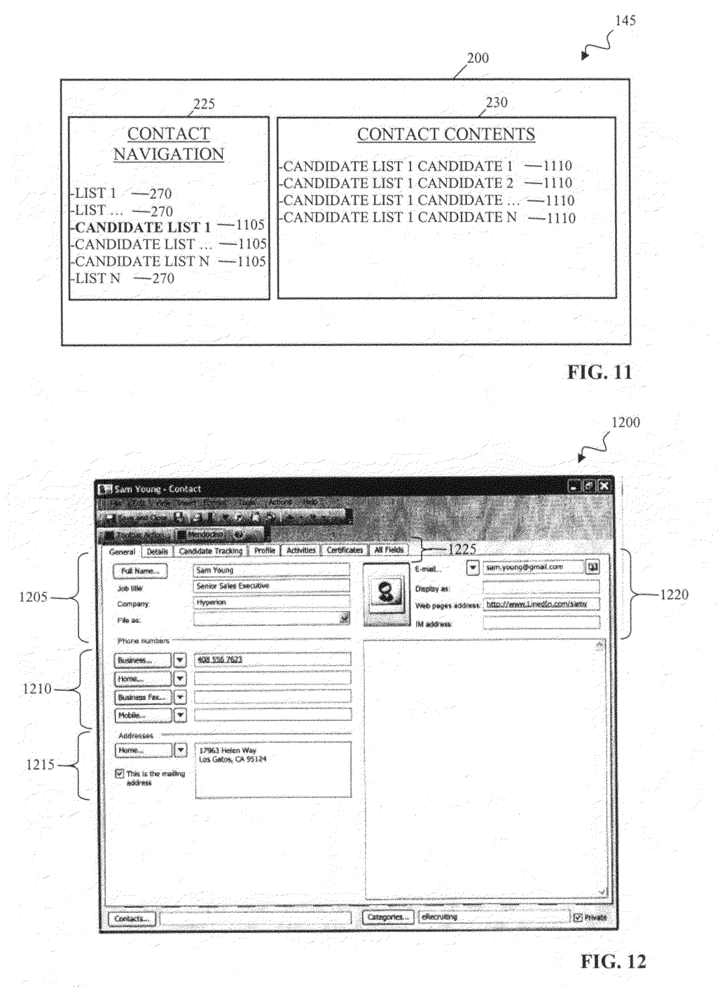

FIG. 11 is a schematic representation of portions of a PIM user interface 145 in which implementations of regions 225, 230 are rendered together on display 200 and can be used by a human user to interact with a recruiting application.

In particular, contact navigation region 225 includes one or more collections of candidates 1105. Candidate collections 1105 archive a collection of candidates to fill recruiting requisitions. The disposition of contacts within candidate collections 1105 can be based on one or more characteristics of the candidates, such as whether the candidate is internal or external, the requisition for which the individual is a candidate, the date on which a candidate's application was received, or the like. For example, each candidate collection 1105 can be associated with a single requisition. The candidates archived in candidate collections 1105 can be drawn from recruiting server 110, either directly or by way of recruiting logic 140 (FIG. 1).

In some implementations, the rendition of the organization of contact archives can facilitate user navigation through the contact archives. For example, a user can navigate to a particular candidate collection 1105 by selecting the candidate collection 1105 from contact navigation region 225. Such a selection can include, e.g., a user double-clicking on the candidate collection 1105 in contact navigation region 225. The navigation to candidate collection 1105 can be used to trigger the rendition of a list of the candidates in candidate collection 1105 in contact contents region 230.

Contact contents region 230 is a portion of display 200 that renders at least some of a collection of one or more candidates. The rendered candidates can include candidates 1110 that are archived in a candidate collection 1105. The rendering of a list of candidates can include, e.g., the display of candidate names, e-mail addresses, postal addresses, phone numbers, and the like. One or more candidate collections 1105 whose content contacts are listed in contact contents region 230 can be identified in contact navigation region 225 using a visual indicium such as boldface type (as shown for “candidate list 1” candidate collection 1105).

In some implementations, the rendition of candidates in contact contents region 230 can facilitate user navigation through an archive of candidates. For example, a user can navigate to a particular candidate 1110 in the candidate archives by selecting that candidate 1110 from a list in contact contents region 230. Such a selection can include, e.g., a user double-clicking on candidates 1110 in contact contents region 230. The navigation to candidates 1110 can be used to trigger the rendition of additional or even all of the information regarding the selected candidate 1110 in a portion of display 200.

FIG. 12 shows a rendition 1200 of information describing a candidate in a portion of a display 200. Rendition 1200 can be rendered together with or separately from portions of PIM user interface 145. For example, rendition 1200 can be rendered in a separate pop-up window or other discrete portion of display 200.

Rendition 1200 can be rendered as part of a user navigation to the relevant candidate. Such navigation can originate from any of a number of different screens as a consequence of user interaction with any of a number of different elements. For example, rendition 1200 can be rendered in response to user interaction with a particular candidate 1110 in contact contents region 230 (FIG. 11). As another example, rendition 1200 can be rendered in response to user interaction with a particular candidate name in collection 810 or a particular personal identification number 815 (FIGS. 8, 10). As another example, rendition 1200 can be rendered in response to user interaction with a particular selection button 845 (FIG. 8).

Rendition 1200 includes generic information 1205 regarding the candidate, phone number information 1210 describing one or more phone numbers of the candidate, postal address information 1215 describing one or more postal addresses of the candidate, and electronic address information 1220 describing one or more electronic addresses regarding the candidate. Rendition 1200 can also include a collection of tabs 1205 that allow a user to navigate to additional information regarding the candidate.

Information 1205, 1210, 1215, 1220 can be received by PIM logic 135 from recruiting server 110 for integration into the display of personal information on PIM interface 145. For example, PIM logic 135 can receive the requisitions by a push or a pull mechanism, either directly from recruiting server 110 or over recruiting logic 140 (FIG. 1). For example, in the illustrated implementation of rendition 1200, information 1205, 1210, 1215, 1220 is presented in accordance with the layout and arrangement used to present contact information in versions of MICROSOFT OUTLOOK. When information 1205, 1210, 1215, 1220 is received from recruiting server 110, recruiting information is presented to a user in a manner with which the user is familiar. This facilitates user interaction with the recruiting information.

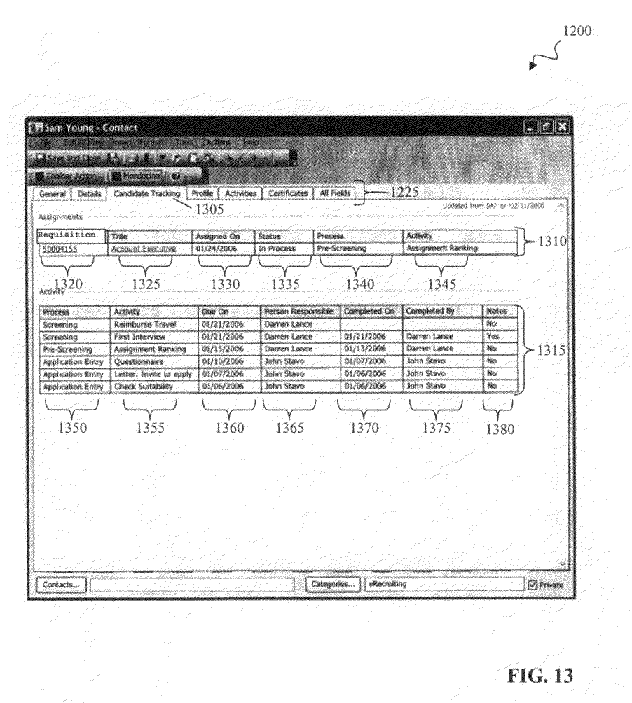

FIG. 13 shows another aspect of candidate rendition 1200. In particular, rendition 1200 is shown after a user has used one of the tabs in collection 1205 to navigate to additional information regarding the candidate. In particular, a user has interacted with a candidate tracking tab 1305 to navigate to candidate tracking information. Candidate tracking information describes the movement of a candidate through the recruiting process. For example, candidate tracking information can include information 1310 identifying requisitions to which the candidate has been assigned and information 1315 describing activities performed in evaluating the candidate for the identified requisitions.

Requisition assignment information 1310 can include one or more numeric identifiers 1320 of a requisition, text descriptions 1325 of requisitions, dates 1330 on which the candidate was assigned to requisitions, descriptions 1335 of the status of the applicant's assignment to requisitions, descriptions 1340 of current processes in the assignment of the applicant to the requisitions, and descriptions 1345 of current activities in the current processes in the assignment of the applicant to the requisitions. One or more of requisition identifiers 1320, requisition descriptions 1325, dates 1330, status descriptions 1335, process descriptions 1340, and activity descriptions 1345 can be links by which a user can navigate to the relevant requisition, date, assignment status, process description, or activity description. For example, a user who double clicks on a requisition identifier 1320 or a requisition description 1325 can navigate to a rendition 500 of that requisition, as shown, e.g., in FIGS. 5-9.

Activity information 1315 can include text descriptions 1355 of activities in the assignment of the applicant to the requisition, along with descriptions 1350 of the processes with which the described activities are associated, dates 1360 on which the described activities are due to be completed, names 1365 of the individuals responsible for completing the described activities, dates 1370 on which the described activities were actually completed, names 1375 of the individuals who actually completed the described activities, and information 1380 describing whether note are associated with the completed activities.

Since information 1310, 1315 can be received by PIM logic 135 from recruiting server 110 for integration into the display of personal information on PIM interface 145, user interaction with the recruiting information can be facilitated. In particular, a user can navigate to information 1310, 1315 using a user interface with which the user is familiar.

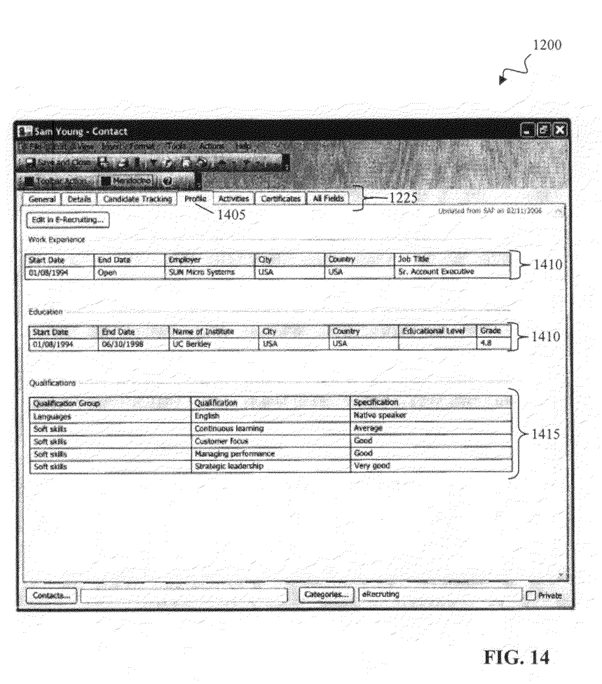

FIG. 14 shows another aspect of candidate rendition 1200. In particular, rendition 1200 is shown after a user has used one of the tabs in collection 1205 to navigate to additional information regarding the candidate. In particular, a user has interacted with a candidate profile tab 1405 to navigate to information profiling the candidate. Candidate profile information describes characteristics of the candidate that may be relevant to requisitioned positions. For example, candidate profile information can include information 1410 describing the candidate's work experience, information 1415 describing the candidate's education, and information 1415 describing other qualifications of the candidate.

Since information 1410, 1415, 1420 can be received by PIM logic 135 from recruiting server 110 for integration into the display of personal information on PIM interface 145, user interaction with the recruiting information can be facilitated. In particular, a user can navigate to information 1410, 1415, 1420 using a user interface with which the user is familiar.

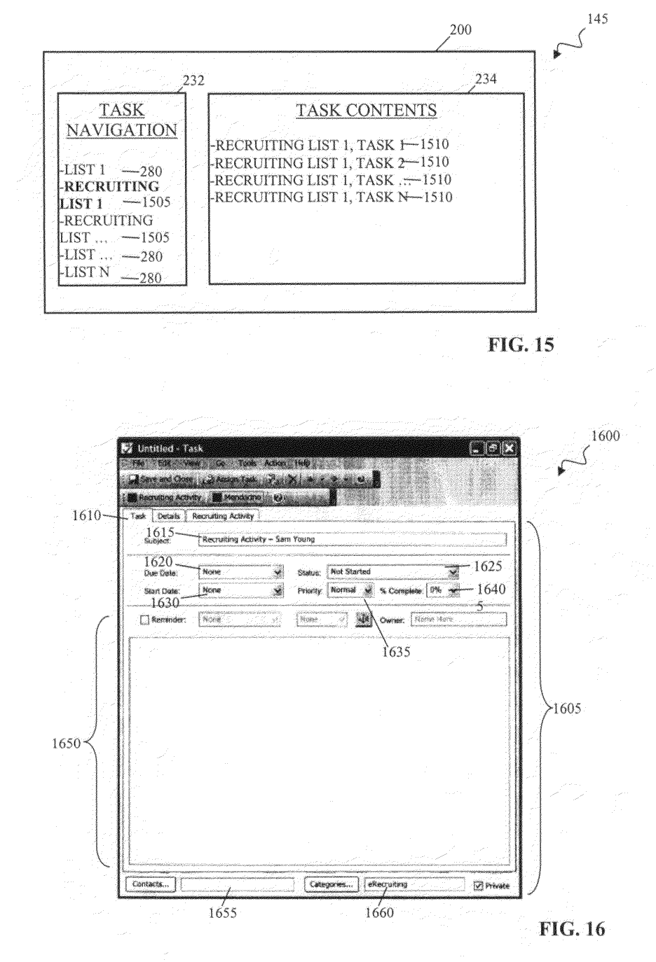

FIG. 15 is a schematic representation of portions of a PIM user interface 145 in which implementations of regions 232, 234 are rendered together on display 200 and can be used by a human user to interact with a recruiting application.

In particular, task navigation region 225 includes one or more collections of tasks lists 280, including one or more lists of recruiting tasks 1505. Recruiting task lists 1505 archive a collection of tasks to be performed in the filling of recruiting requisitions. The disposition of tasks within recruiting task lists 1505 can be based on one or more characteristics of the tasks, such as the department or the requisition with which the task is associated, the personnel assigned to manage the performance of the tasks, or the like. For example, each recruiting task list 1505 can be the tasks for which a single human resources individual is responsible. The tasks archived in recruiting task lists 1505 can be drawn from recruiting server 110, either directly or by way of recruiting logic 140 (FIG. 1).

In some implementations, the rendition of the organization of task archives can facilitate user navigation through the task archives. For example, a user can navigate to a particular recruiting task list 1505 by selecting recruiting task list 1505 from task navigation region 232. Such a selection can include, e.g., a user double-clicking on the recruiting task list 1505 in contact navigation region 225. The navigation to recruiting task list 1505 can be used to trigger the rendition of a list of the tasks in recruiting task list 1505 in task contents region 234.

Task contents region 234 is a portion of display 200 that renders at least some of a collection of one or more tasks. The rendered tasks can include tasks 1510 that are archived in a recruiting task list 1505. The rendering of a list of tasks can include, e.g., the display of the subject or title of the task, the status of the task, the due date of the task, the percent completion of the task, or the like. One or more recruiting task lists 1505 whose content tasks are listed in task contents region 234 can be identified in task navigation region 232 using a visual indicium such as boldface type (as shown for “recruiting list 1” recruiting task list 1505).

In some implementations, the rendition of tasks in task contents region 234 can facilitate user navigation through an archive of tasks. For example, a user can navigate to a particular task 1510 in the task archives by selecting that task 1110 from a list in task contents region 234. Such a selection can include, e.g., a user double-clicking on tasks 1510 in task contents region 234. The navigation to tasks 1510 can be used to trigger the rendition of additional or even all of the information regarding the selected task 1510 in a portion of display 200.

FIG. 16 shows a rendition 1600 of information describing a task in a portion of a display 200. Rendition 1600 can be rendered together with or separately from portions of PIM user interface 145. For example, rendition 1600 can be rendered in a separate pop-up window or other discrete portion of display 200.

Rendition 1600 can be rendered as part of a user navigation to the relevant task. Such navigation can originate from any of a number of different screens as a consequence of user interaction with any of a number of different elements. For example, rendition 1600 can be rendered in response to user interaction with a particular task 1510 in task contents region 234 (FIG. 15). As another example, rendition 1600 can be rendered in response to user interaction with a particular grouping of activity information 910 in a rendition of activity information 905 (FIGS. 9, 10). As another example, rendition 1600 can be rendered in response to user interaction with a particular process description 1350 in a collection of activity information 1315 (FIG. 13).

Rendition 1600 includes a collection of generic information 1605 regarding the task under a “task” tab 1610. Generic information 1605 include information 1615 describing the subject of the task, date information 1620 describing the due date of the task, status information 1625 describing the status of the task, start date information 1630 describing the start date of the task, priority information 1635 describing the priority of the task, and completion information 1640 describing progress in the task, reminder information describing reminders regarding the performance of the task, contact information 1655 identifying any contacts associated with the task, and category information 1660 describing the category of the task.

Information 1615, 1620, 1625, 1630, 1635, 1640, 1645, 1650, 1655, 1660 can be received by PIM logic 135 from recruiting server 110 for integration into the display of personal information on PIM interface 145. For example, PIM logic 135 can receive the requisitions by a push or a pull mechanism, either directly from recruiting server 110 or over recruiting logic 140 (FIG. 1). For example, in the illustrated implementation of rendition 1600, information 1615, 1620, 1625, 1630, 1635, 1640, 1645, 1650, 1655, 1660 is presented in accordance with the layout and arrangement used to present contact information in versions of MICROSOFT OUTLOOK. When information 1615, 1620, 1625, 1630, 1635, 1640, 1645, 1650, 1655, 1660 is received from recruiting server 110, recruiting information is presented to a user in a manner with which the user is familiar. This facilitates user interaction with the recruiting information.

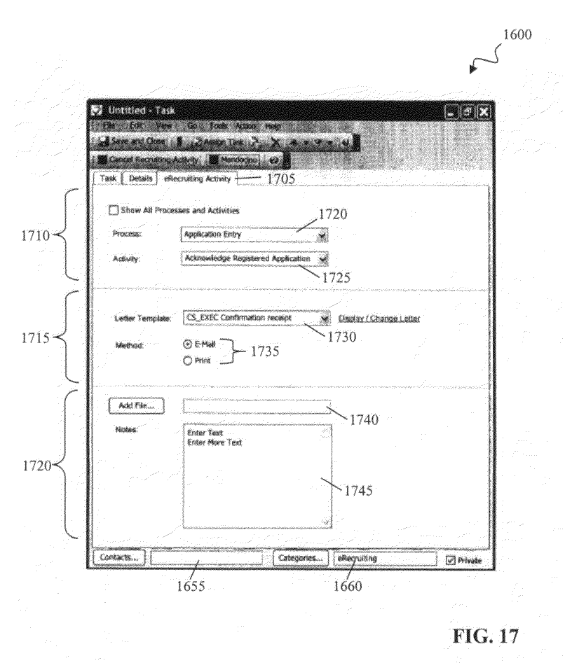

FIG. 17 shows another aspect of task rendition 1600. In particular, rendition 1600 is shown after a user has used an e-recruiting tab 1705 to navigate to recruiting-specific information regarding the task. Recruiting-specific information describes characteristics of the task that relate to recruiting, such as those characteristics defined in a recruiting server 110 (FIG. 1). For example, recruiting-specific information can include recruiting context information 1710, identifiers 1715 of recruiting tools for performing the task, and tools 1720 for adding additional information to the task.

Recruiting context information 1710 can describe the context of the task in the recruiting process. For example, recruiting context information 1710 can include an identifier 1720 of a recruiting process with which the task is associated and an identifier 1725 of a recruiting activity with which the task is associated. Recruiting tool identifiers 1715 can identify one or more tools available to a recruiting system. For example, recruiting tool identifiers 1715 can identify letter templates 1730 that are suited for performance of a task, along with an indication 1735 of whether the letter is to be sent by electronic or postal mail. Tools 1720 for adding additional information to the task can include a file add tool 1740 that allows a file to be added to the task and a text entry tool 1745 that allows a user to enter additional text into the task.

Since information 1710 and identifiers 1715 can be received by PIM logic 135 from recruiting server 110 for integration into the display of personal information on PIM interface 145, user interaction with the recruiting information can be facilitated. In particular, a user can navigate to information 1710 and identifiers 1715 using a user interface with which the user is familiar.

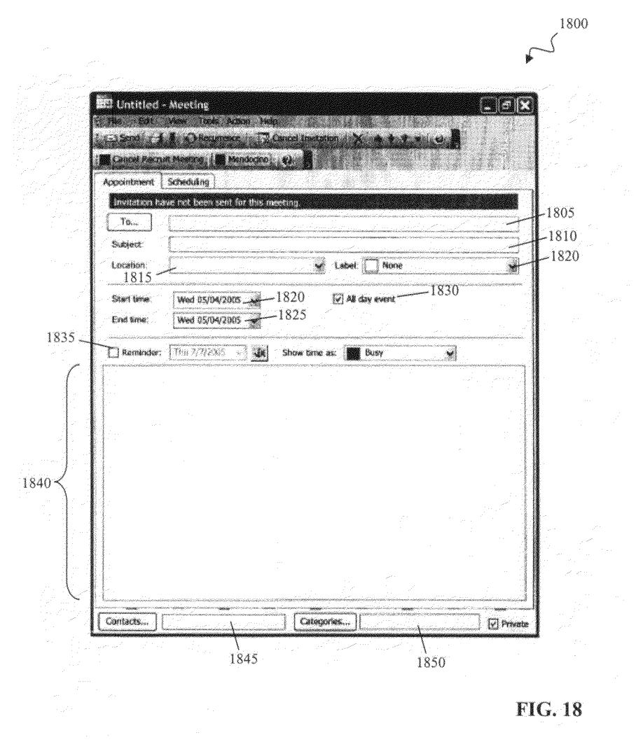

Another example of tools that are available to a recruiting system and can be identified in recruiting tool identifier 1715 are tools that use the services provided by a PIM server 105. For example, FIG. 18 shows a rendition 1800 of a meeting request in a portion of a display 200. Rendition 1800 can be generated in response to user interaction with elements of a PIM user interface 145 and/or in response to user interaction with elements of a user interface of a recruiting system, as discussed further below.

The meeting request rendered in rendition 1800 can include information 1805 identifying one or more individuals to whom the meeting request is to be sent, information 1810 describing the subject of the meeting, information 1815 describing the location of the meeting, information 1820, 1825, 1830 describing the timing and/or duration of the meeting, information 1835 describing whether or not a reminder of the meeting is to be sent, additional information 1840 describing the meeting, information 1845 describing contacts associated with the meeting, and information 1850 describing the category of the meeting. For example, category information 1850 can describe that the meeting is part of a recruiting process or category information 1850 can describe the context of the meeting in a recruiting process.

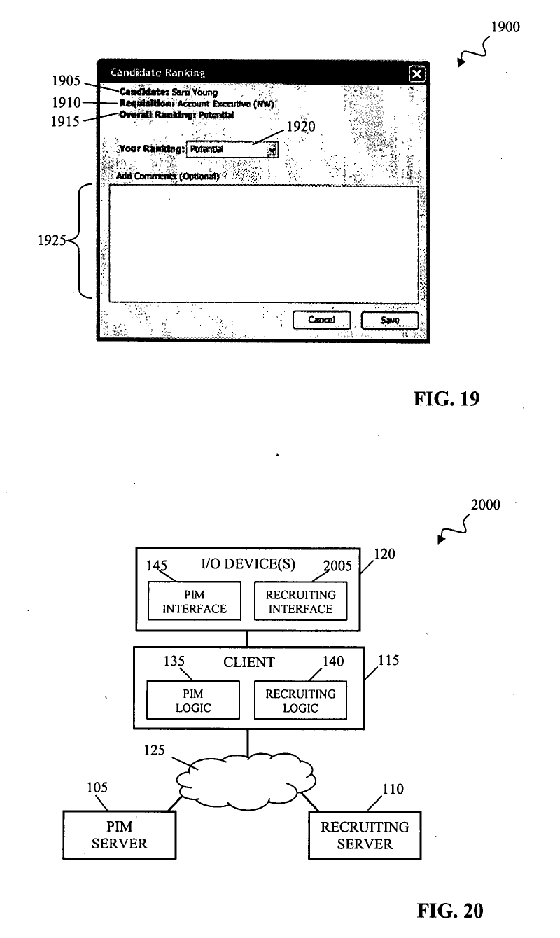

Another example of tools that are available to a recruiting system and can be identified in recruiting tool identifier 1715 are tools that use the services provided by a recruiting system. For example, FIG. 19 shows a rendition 1900 of a candidate ranking form in a portion of a display 200. Rendition 1900 can be generated in response to user interaction with elements of a PIM user interface 145 and/or in response to user interaction with elements of a user interface of a recruiting system, as discussed further below.

The candidate ranking form rendered in rendition 1900 can include information 1905 identifying the candidate to be ranked, information 1910 describing the requisition for which the candidate is to be ranked, information 1915 describing the current overall ranking of the candidate. The candidate ranking form rendered in rendition 1900 can also include one or more input widget, such as a pull-down ranking input menu 1920 and a text comment input field 1925.

FIG. 20 is a schematic representation of a system landscape 2000 in which a recruiting application can interact with a human user both via the user interface of a personal information manager (PIM) and via the user interface of a recruiting application. In particular, a recruiting application can convey information to a human user and receive information from the human user via both the user interface of a personal information manager (PIM) and a user interface of a recruiting application. In addition to PIM server 105, recruiting server 110, client 115, I/O devices 120, data links 125, PIM logic 135, recruiting logic 140, and PIM interface 145, system landscape 2000 also includes a recruiting interface 2005.

Recruiting interface 2005 is a mechanism for the exchange of information with a human user and is generated in accordance with recruiting logic 140 for integrating and managing the data and processes associated with the recruiting of individuals to an organization. The exact nature of recruiting interface 2005 can depend on the I/O devices 120 on which recruiting interface 2005 is rendered. For example, if I/O devices 120 include a speaker, recruiting interface 2005 can include sound elements. As another example, if I/O devices 120 include a display (such as a computer monitors or the LCD screen of a PDA), recruiting interface 2005 can include visual elements.

Since recruiting interface 2005 is generated in accordance with recruiting logic 140, recruiting interface 2005 can provide interaction mechanisms that are specific to the recruiting of individuals to an organization. Moreover, the consequences of those interactions can trigger the performance of data processing activities by PIM logic 135 and/or the display of information on PIM interface 145. For example, recruiting interface 2005 can be used to create a requisition, a contact, and/or a task that can be rendered on PIM interface 145, as discussed above.

As another example, recruiting interface 2005 can be used to modify an existing requisition, contact, and/or task, and the modified requisition, contact, and/or task can be rendered on PIM interface 145. For example, a user can interact with recruiting interface 2005 to, e.g., assign the performance of recruiting activities, to perform recruiting activities, to assign candidates to requisitions, and the like. Such modifications can be performed in accordance with the roles and authorizations provided by recruiting logic 140. Such modifications can be reflected in the rendition of the modified requisitions, contacts, and/or tasks on recruiting interface 2005.

A number of implementations have been described. Nevertheless, it will be understood that various modifications may be made. For example, the techniques described herein can be used in contexts other than the illustrated system landscape 100. For example, database servers can be added, PIM and recruiting services can be provided by additional or fewer systems (including a system that interacts directly with I/O device(s) 120). As another example, the techniques can be used in other contexts, such as a peer-to-peer network. Accordingly, other implementations are within the scope of the following claims.

What is claimed is:

1. A method comprising:
receiving, at a user interface of a personal information manager, requisition information and candidate information from a recruiting server that manages data associated with recruiting individuals to an enterprise; and
rendering, in the personal information manager user interface, the requisition information and the candidate information,
wherein the personal information manager user interface is generated in accordance with the logic of a personal information manager for the management of personal information of a human user,
the requisition information describes a request to fill a position, and
the candidate information describes an individual who is a candidate to fill the position.

2. The method of claim 1, wherein rendering the requisition information comprises rendering identifiers of two or more candidates to fill the requisition in association with an identifier of the requisition.

3. The method of claim 2, wherein the method further comprises:
receiving user interaction identifying a first of the identifiers; and
in response, rendering at least some candidate information describing an individual who is associated with the first of the identifiers.

4. The method of claim 1, wherein rendering the requisition information comprises rendering a description of one or more requirements on candidates to fill the requisition in association with an identifier of the requisition.

5. The method of claim 1, wherein rendering the requisition information comprises rendering a description of a salary for the position in association with an identifier of the requisition.

6. The method of claim 1, wherein rendering the requisition information comprises:
rendering, in a region of the personal information manager user interface, an identifier of a collection of requisitions and an identifier of a collection of communications that have been archived for the human user; and
in response to user interaction with the identifier of the requisition collection, rendering information describing the requisitions in the requisition collection.

7. The method of claim 1, wherein rendering the candidate information comprises rendering identifiers of two or more requisitions for which the individual is a candidate in association with an identifier of the candidate.

8. The method of claim 7, wherein the method further comprises:
receiving user interaction identifying a first of the identifiers; and
in response, rendering at least some requisition information describing a requisition that is associated with the first of the identifiers.

9. The method of claim 1, wherein rendering the requisition information comprises:
rendering, in a region of the personal information manager user interface, an identifier of a collection of candidate and an identifier of a collection of contacts that have been archived for the human user; and
in response to user interaction with the identifier of the candidate collection, rendering information describing the candidates in the candidate collection.

10. The method of claim 1, further comprising:
receiving, at the user interface, recruiting task information from the recruiting server; and
rendering, in the personal information manager user interface, the recruiting task information,
wherein the recruiting task information describes a task performed in filling the position.

11. The method of claim 1, wherein rendering the recruiting task information comprises:
rendering, in a region of the personal information manager user interface, an identifier of a collection of recruiting tasks and an identifier of a collection of other tasks that have been archived for the human user; and
in response to user interaction with the identifier of the recruiting task collection, rendering information describing the recruiting tasks in the recruiting task collection.

12. The method of claim 1, wherein rendering the recruiting task information comprises rendering identifiers of two or more recruiting tasks performed in filling a first requisition in association with an identifier of the first requisition.

13. The method of claim 12, wherein the method further comprises:
receiving user interaction identifying a first of the identifiers; and
in response, rendering at least some recruiting task information describing a recruiting task that is associated with the first of the identifiers.

14. The method of claim 1, wherein rendering the recruiting task information comprises rendering identifiers of two or more recruiting tasks performed in recruiting a first candidate in association with an identifier of the first candidate.

15. The method of claim 14, wherein the method further comprises:
receiving user interaction identifying a first of the identifiers; and
in response, rendering at least some recruiting task information describing a recruiting task that is associated with the first of the identifiers.

16. A system comprising:
a recruiting server that provides services related to a recruiting process and manages data associated with the recruiting process;
a personal information manager server that provides services related to management of a user's personal information; and
a personal information manager user interface on one or more I/O devices, wherein the personal information manager user interface integrates, into a single display screen, personal information from the personal information manager server and the data associated with the recruiting process.

17. The system of claim 16, wherein the personal information manager user interface comprises a display screen that comprises:
a first region for displaying names of mail folders, the first region including a name of a collection of requisitions; and
a second region for displaying contents of mail folders, the second region including names of requisitions in the collection of requisitions.

18. The system of claim 16, wherein the personal information manager user interface comprises a display screen that comprises:
a first region for displaying names of contact lists, the first region including a name of a collection of candidates; and
a second region for displaying contents of contact lists, the second region including names of candidates in the collection of candidates.

19. The system of claim 16, wherein the personal information manager user interface comprises a display screen that comprises:
a first region for displaying names of task lists, the first region including a name of a collection of recruiting tasks; and
a second region for displaying contents of task lists, the second region including names of recruiting tasks in the collection of recruiting tasks.

20. The system of claim 16, wherein the personal information manager user interface comprises a rendition of a requisition, wherein the requisition comprises a request to fill a position.

21. The system of claim 20, wherein the requisition rendition comprises a collection of identifiers of one or more candidates who have been assigned to the requisition for consideration in filling the position.

22. The system of claim 20, wherein the requisition rendition comprises:
basic information regarding the position; and
salary information regarding a salary for the position.

23. The system of claim 16, wherein the personal information manager user interface comprises a rendition of a recruiting task, wherein the recruiting task comprises a task performed in filling a position.

24. The system of claim 23, wherein the recruiting task rendition comprises recruiting context information describing a context of the recruiting task in a recruiting process.

25. The system of claim 23, wherein the recruiting task rendition comprises an identifier of a letter template that is suited for performance of the recruiting task.

26. The system of claim 16, wherein the personal information manager user interface comprises a rendition of a candidate, wherein the candidate comprises an individual to be considered for filling a position.

27. The system of claim 26, wherein the candidate rendition comprises a collection of two or more identifiers of requisitions for which the individual is to be considered.

28. The system of claim 26, wherein the candidate rendition comprises a collection of two or more identifiers of tasks in recruiting the individual to the position.

29. The system of claim 26, wherein the candidate rendition comprises a profile of qualifications of the individual.

30. The system of claim 16, wherein the system further comprises:
a recruiting user interface on the one or more I/O devices, wherein the recruiting user interface is operable to modify the data associated with the recruiting process.
